(19) United States
(12) Patent Application Publication
(10) Pub. No.: US 2016/0352783 A1
(43) Pub. Date: Dec. 1, 2016

(54) Partitioning Media Data

(71) Applicant: Microsoft Technology Licensing, LLC, Redmond, WA (US)

(72) Inventors: Amer Aref Hassan, Kirkland, WA (US); Andrew Nicholas Paul Smith, London (GB)

(21) Appl. No.: 14/723,170

(22) Filed: May 27, 2015

(51) Int. Cl. H04L 29/06

(52) U.S. Cl. CPC H04L 65/1066; H04L 65/60

(57) ABSTRACT

Techniques for partitioning media data are described. According to various embodiments, a set of wireless access points are selected for receiving wireless transmission of media data of a communication session. Media data of the communication session is partitioned and transmitted across the wireless access points by a device participating in the communication session and for receipt by another device participating in the communication session.

### BACKGROUND

Modern communication systems have an array of capabilities, including integration of various communication modalities with different services. For example, voice/video communications, instant messaging, data/application sharing, white-boarding, and other forms of communication may be combined with presence and availability information for users. Such systems enable users to engage in communication sessions to exchange different types of communication media, such as voice data, video data, content sharing, and combinations thereof. Furthermore, collaboration systems that enable users to share and collaborate in creating and modifying various types of documents and content may be integrated with multimodal communication systems providing different kinds of communication and collaboration capabilities. Such integrated systems are sometimes referred to as Unified Communication (UC) systems.

While UC systems provide for increased flexibility in communications, they also present a number of implementation challenges. For instance, a UC system typically utilizes multiple interconnected networks to route various communications. Since different networks may be managed by different entities, challenges thus arise in maintaining communications quality for communications that are routed among independently managed networks. Further, UC is typically implemented via software that can be loaded on mobile devices, e.g., tablets, smartphones, laptops, and so forth. Thus, techniques for managing UC&C communication traffic typically have to be fluid and dynamic to accommodate changing connection scenarios.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Techniques for partitioning media data are described. According to various embodiments, a set of wireless access points are selected for receiving wireless transmission of media data of a communication session. Media data of the communication session is partitioned and transmitted across the wireless access points by a device participating in the communication session and for receipt by another device participating in the communication session.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items.

FIG. 1 is an illustration of an environment in an example implementation that is operable to employ techniques discussed herein.

FIG. 2 illustrates an example implementation scenario for partitioning media data of a communication session in accordance with one or more embodiments.

FIG. 3 illustrates an example implementation scenario for generating separate signals for media data of a communication session in accordance with one or more embodiments.

FIG. 4 illustrates an example implementation scenario for partitioning a data stream in accordance with one or more embodiments.

FIG. 5 illustrates an example implementation scenario for partitioning a data stream in accordance with one or more embodiments.

FIG. 6 illustrates an example implementation scenario for partitioning a data stream in accordance with one or more embodiments.

FIG. 7 illustrates an example implementation scenario for combining data transmitted in separate signals in accordance with one or more embodiments.

FIG. 8 illustrates an example implementation scenario for combining data transmitted in separate signals in accordance with one or more embodiments.

FIG. 9 is a flow diagram that describes steps in a method for partitioning data of a communication session in accordance with one or more embodiments.

FIG. 10 is a flow diagram that describes steps in a method for selecting access points for wireless transmission of data of a communication session in accordance with one or more embodiments.

FIG. 11 is a flow diagram that describes steps in a method for selecting a partitioning matrix based on attributes of an access point in accordance with one or more embodiments.

FIG. 12 is a flow diagram that describes steps in a method for selecting a partitioning matrix to maximize distance between media streams in accordance with one or more embodiments.

FIG. 13 is a flow diagram that describes steps in a method for combining media streams in accordance with one or more embodiments.

FIG. 14 illustrates an example system and computing device as described with reference to FIG. 1, which are configured to implement embodiments of techniques described herein.

### DETAILED DESCRIPTION

Overview

Techniques for partitioning media data are described. According to various implementations, media data of a communication session is partitioned and transmitted across multiple different wireless access points. Generally, utilizing multiple access points for wireless transmission increases resource utilization for underused access points, and reduces work load on heavily used access points. Further, partitioning media data and transmitting the media data over multiple access points decreases the required transmit power for transmitting individual streams of media data, and increases the ability of a receiving device to correctly decode the media data.

In an example scenario, a client device is participating in a communication session. Generally, a communication session refers to an exchange of communication media between communication endpoints, such as part of a real-time communication session between users of different communication endpoints. Examples of a communication session include a Voice over Internet Protocol (VoIP) call, a video call, text messaging, a file transfer, and/or combinations thereof. In at least some implementations, a communication session represents a Unified Communications (UC) session.

Further to the example scenario, the client device detects that multiple wireless access points are available for receiving wireless transmission of media data of the communication session from the client device. The client device then selects a set of wireless access points from the available access points to be used for receiving wireless transmission, such as based on various criteria discussed below for selecting wireless access points.

To prepare media data generated at the client device for the communication session for wireless transmission, the media data is encoded to generate an encoded media stream. Generally, encoding applies error correction coding to the media data, such as Forward Error Correction (FEC). The encoded media stream is then partitioned into multiple partitions for transmission across the selected set of wireless access points. The partitions, for instance, represent sub-streams that each include different portions (e.g., encoded bits) from the original encoded media stream.

According to various implementations, the encoded media stream is partitioned using a partitioning matrix. The partitioning matrix, for instance, represents a puncturing matrix that is used to puncture the encoded media stream. Punctured portions of the encoded media stream are used to generate one partition, and remaining portions of the media stream are used generate another partition. Thus, the different partitions represent data streams that include different respective portions of encoded media data. Generally, the encoded media stream is partitioned based on various partitioning criteria, such as a number of wireless access points to be used, performance attributes of the wireless access points, signal quality across networks involved in transporting the partitions, and so forth.

The partitions are then wirelessly transmitted by the client device to different respective wireless access points for forwarding to the endpoint device. After the partitions are received and forwarded from the wireless access points, the partitions are combined to form a combined media stream. For instance, the partitions are combined at the receiving endpoint device, or at some intermediate network component. The combined media stream is then decoded to reveal media data that is output by the endpoint device as part of the communication session, such as video data, audio data, content, and so forth.

In the following discussion, an example environment is first described that is operable to employ techniques described herein. Next, a section entitled “Example Implementation Scenarios” describes some example implementation scenarios in accordance with one or more embodiments. Following this, a section entitled “Example Procedures” describes some example procedures in accordance with one or more embodiments. Finally, a section entitled “Example System and Device” describes an example system and device that are operable to employ techniques discussed herein in accordance with one or more embodiments.

Having presented an overview of example implementations in accordance with one or more embodiments, consider now an example environment in which example implementations may by employed.

Example Environment

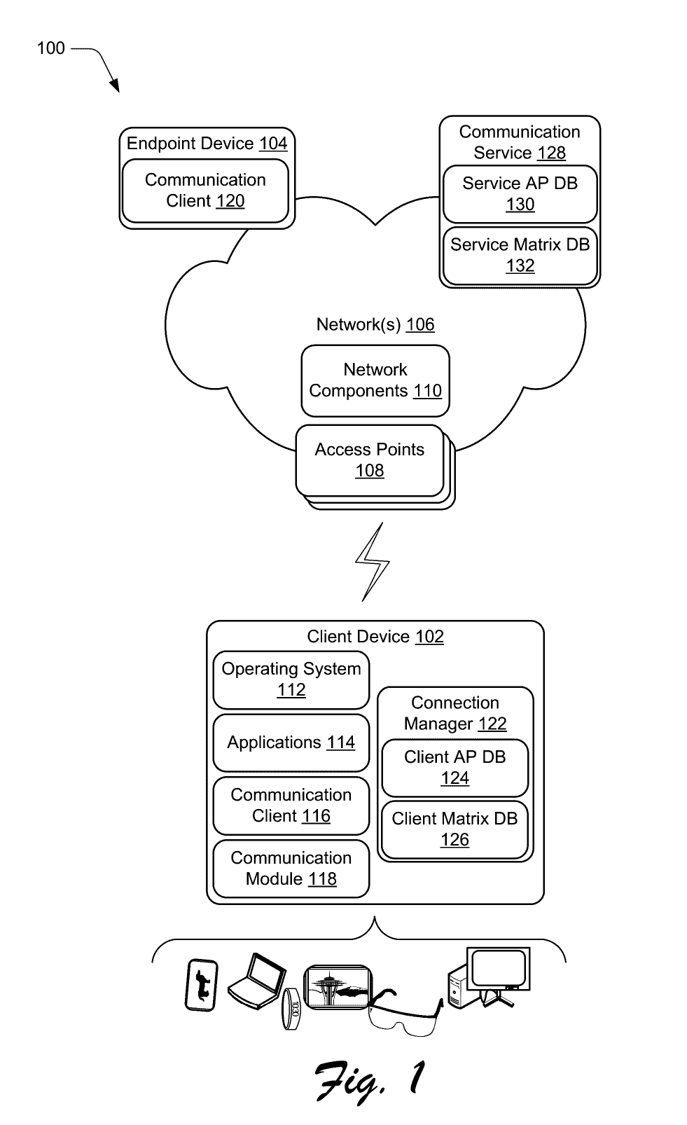

FIG. 1 is an illustration of an environment 100 in an example implementation that is operable to employ techniques partitioning media data described herein. Generally, the environment 100 includes various devices, services, and networks that enable communication via a variety of different modalities. For instance, the environment 100 includes a client device 102 and an endpoint device 104 connected to a network 106. The client device 102 and the endpoint device 104 may be configured in a variety of ways, such as a traditional computer (e.g., a desktop personal computer, laptop computer, and so on), a mobile station, an entertainment appliance, a smartphone, a wearable device, a netbook, a game console, a handheld device (e.g., a tablet), and so forth.

The network 106 is representative of a network that provides the client device 102 with connectivity to various networks and/or services, such as the Internet. The network 106 may provide the client device 102 with connectivity via a variety of different connectivity technologies, such as broadband cable, digital subscriber line (DSL), wireless cellular, wireless data connectivity (e.g., WiFi™), T-carrier (e.g., T1), Ethernet, and so forth. In at least some implementations, the network 106 represents different interconnected wired and wireless networks.

The network 106 includes wireless access points (APs) 108, which are representative of functionalities for providing wireless connectivity to the network 106. The APs 108 may be implemented using a variety of different wireless technologies, such as wireless broadband (e.g., WiFi™), wireless cellular, Bluetooth, near field communication (NFC), ZigBee, and so forth. In at least some implementations, at least some of the APs 108 are implemented via a different wireless technology than others of the APs 108.

The wireless network 106 further includes network components 110. Generally, the network components 110 are representative of hardware and logic for implementing and managing the networks 106. Examples of the network components 110 include network controllers, gateways, routers, switches, and so forth.

The client device 102 includes a variety of different functionalities that enable various activities and tasks to be performed. For instance, the client device 102 includes an operating system 112, applications 114, a communication client 116, and a communication module 118. Generally, the operating system 112 is representative of functionality for abstracting various system components of the client device 102, such as hardware, kernel-level modules and services, and so forth. The operating system 112, for instance, can abstract various components of the client device 102 to the applications 114 to enable interaction between the components and the applications 114.

The applications 114 represent functionalities for performing different tasks via the client device 102. Examples of the applications 114 include a word processing application, a spreadsheet application, a web browser, a gaming application, and so forth. The applications 114 may be installed locally on the client device 102 to be executed via a local runtime environment, and/or may represent portals to remote functionality, such as cloud-based services, web apps, and so forth. Thus, the applications 114 may take a variety of forms, such as locally-executed code, portals to remotely hosted services, and so forth.

The communication client 116 is representative of functionality to enable different forms of communication via the client device 102, such as for communication between the client device 102 and the endpoint device 104. Examples of the communication client 116 include a voice communication application (e.g., a VoIP client), a UC client, a video communication application, a messaging application, a content sharing application, and combinations thereof. The communication client 116, for instance, enables different communication modalities to be combined to provide diverse communication scenarios. In at least some implementations, the communication client 116 represents an application that is installed on the client device 102. Additionally or alternatively, the communication client 116 can be implemented as a portal to a remote application, such as accessed via a web browser, a web application, and so forth.

According to one or more implementations, communication between the client device 102 and the endpoint device 104 occurs between the communication client 116 and a communication client 120 of the endpoint device 104. The communication client 120, for instance, represents an instance of the communication client 116. For example, a communication session between the client device 102 and the endpoint device 104 represents an exchange of communication media between the communication client 116 and the communication client 120.

The communication module 118 of the client device 102 is representative of functionality for enabling the client device 102 to communicate data over wired and/or wireless connections. For instance, the communication module 118 represents hardware and logic for data communication over the network 106 via a variety of different wired and/or wireless technologies and protocols. As further detailed below, the communication module 118 includes various functionalities for processing data to be transmitted wirelessly, such as functionality for encoding, encryption, partitioning, modulation, and so forth.

The client device 102 further includes a connection manager 122, which is representative of functionality to perform various network connectivity tasks for the client device 102. For instance, the connection manager 122 enables the client device 102 to connect to one or more of the APs 108 to enable wireless connectivity to the network 106. In at least some implementations, the connection manager 122 is representative of functionality for performing various aspects of techniques for partitioning media data discussed herein.

The connection manager 122 maintains a client access point (AP) database (DB) 124 and a client matrix DB 126a. The client AP DB 124 is representative of functionality for storing attributes of different APs 108. Examples of access point attributes that may be stored by the client AP DB 124 include identifiers for different APs, quality indicators for different APs (e.g., based on historic signal quality for communication sessions over different APs), AP types, AP technologies, and so forth. In at least some implementations, the client AP DB 124 indicates whether a particular AP is a preferred AP, e.g., is preferred over other APs for providing wireless connectivity to the client device 102.

The client matrix DB 126 is representative of functionality for storing different partitioning matrices that can be employed for partitioning streams of media data. A partitioning matrix, for instance, represents a particular puncturing pattern (e.g., a puncturing matrix) to be applied to a media stream to extract data from the media stream and generate multiple sub-streams, i.e., partitions. According to various implementations, the client matrix DB 126 stores partitioning matrices based on their suitability for different partitioning scenarios. For instance, partitioning matrices are configured to be used to partition media streams for wireless access points of different quality levels, to partition media streams to maximize differences (e.g., Hamming distance) between partitions, and so forth.

The environment 100 further includes a communication service 128, which is representative of a service to perform various tasks for management of communication between the client device 102 and the endpoint device 104. The communication service 128, for instance, can manage initiation, moderation, and termination of communication sessions. Examples of the communication service 128 include a VoIP service, an online conferencing service, a UC service, and so forth. In at least some implementations, the communication service 128 may be implemented as or be connected to a private branch exchange (PBX) in communication with a Public Switched Telephone Network (“PSTN”) to enable voice communication between the client device 102 and the endpoint device 104.

According to one or more implementations, the communication clients 116, 120 are managed and/or hosted by the communication service 128. For instance, the communication clients 116, 120 represent interfaces to communication services provided by the communication service 128.

The communication service 128 maintains a service access point (AP) database (DB) 130 and a service matrix DB 132. The service AP DB 130 is representative of functionality for storing attributes of different APs. Examples of access point attributes that may be stored by the service AP DB 130 include identifiers for different APs, quality indicators for different APs (e.g., based on historic signal quality for communication sessions over different APs), AP types, AP technologies, and so forth. The service AP DB 130 may also indicate whether a particular AP is a preferred AP, e.g., is preferred over other APs for providing wireless connectivity to the client device 102. In at least some implementations, AP attributes from the service AP DB 130 are propagated to the client AP DB 124.

The service matrix DB 132 is representative of functionality for storing different partitioning matrices that can be employed for partitioning streams of media data. In at least some implementations, the communication service 128 propagates partitioning matrices from the service matrix DB 132 to the client matrix DB 126.

The various entities and functionalities discussed in the environment 100 may be implemented in software, hardware, firmware, and/or combinations thereof. Further details and implementations of the various entities of the environment 100 are discussed below.

In at least some implementations, functionalities discussed with reference to the connection manager 122 and/or the communication module 118 may be implemented at an application layer of the client device 102. For instance, in at least some implementations, the connection manager 122 and/or the communication module 118 represents functionalities of the communication client 116.

Having described an example environment in which the techniques described herein may operate, consider now some example implementation scenarios for partitioning media data in accordance with one or more embodiments.

Example Implementation Scenarios

The following section describes example implementation scenarios for partitioning media data in accordance with one or more embodiments. The implementation scenarios may be implemented in the environment 100 discussed above, and/or any other suitable environment.

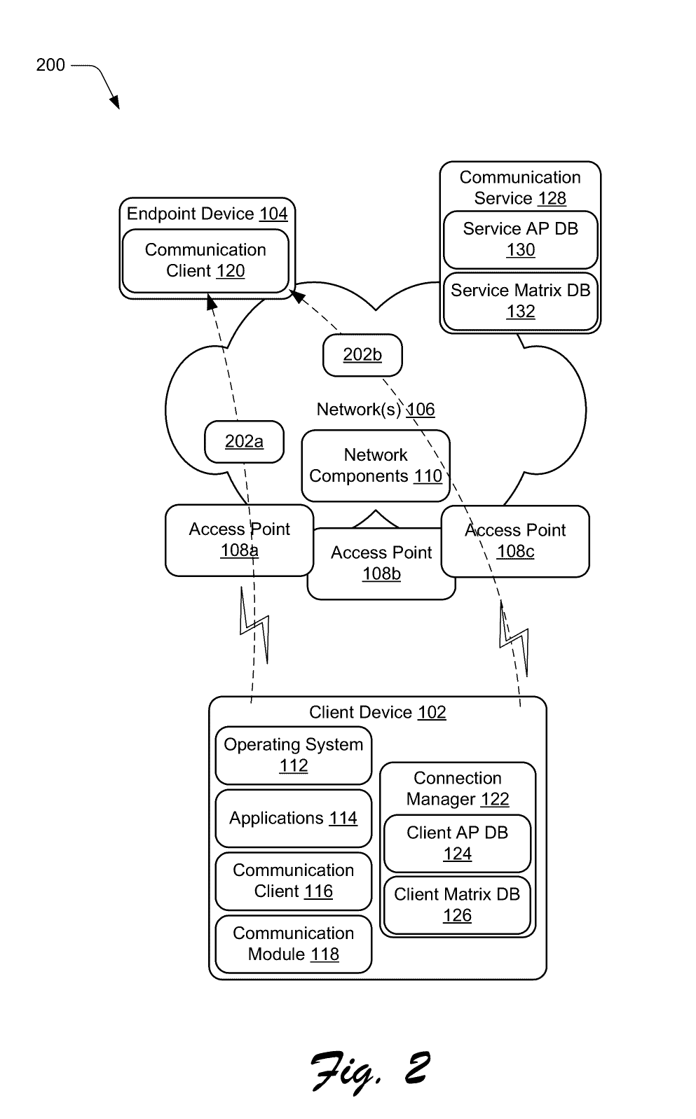

FIG. 2 illustrates an example implementation scenario 200 for partitioning media data of a communication session in accordance with one or more implementations. In the scenario 200, a user of the client device 102 performs an action to initiate a communication session between the client device 102 and the endpoint device 104. The user, for instance, interacts with the communication client 116 to initiate a communication session, such as by entering a phone number, selecting a contact entry, and so forth. Examples of the communication session include a VoIP call, a video call, a UC session, and/or combinations thereof.

Further to the scenario 200, the connection manager 122 detects that an AP 108a, an AP 108b, and an AP 108c are available for wirelessly routing data of the communication session between the client device 102 and the endpoint device 104. Generally, the APs 108a-108c represent instances of the APs 108 introduced above. Accordingly, the connection manager 122 decides to utilize the AP 108a and the AP 108c to transmit data of the communication session from the client device 102. For instance, the connection manager 122 ascertains that the APs 108a, 108c have a higher signal quality than the AP 108c. The client AP DB 124, for example, identifies the APs 108a, 108c and specifies quality indicators for the APs 108a, 108c. In at least some implementations, the client AP DB 124 lists APs that meet a threshold signal quality, and/or ranks APs according to their signal quality. Generally, signal quality is based on current and/or historic signal quality, such as based on signal quality experienced for current and/or historic communication sessions.

To utilize the APs 108a, 108c, the connection manager 122 instructs the communication module 118 to partition data of the communication session into two separate data streams and to communicate the separate data streams to the APs 108a, 108c. As further detailed below, the connection manager 122 provides logic for partitioning data of a communication session, such as a partitioning matrix to be used to partition the data into separate data streams. The connection manager 122 further instructs the communication module 118 to communicate one data stream to the AP 108a, and the other data stream to the AP 108c.

Accordingly, the communication module 118 receives communication session data (e.g., from the communication client 116), and partitions the data into a signal 202a and a signal 202b. Generally, the signals 202a, 202b include encoded media data of the communication session that is processed in various ways, such as by encoding, partitioning, modulating, and so forth. Example ways for partitioning media data are detailed below. The signal 202a is then transmitted to the AP 108a, and the signal 202b is transmitted to the AP 108c. The APs 108a, 108c then forward their respective signals for receipt by the endpoint device 104 as part of a communication session.

In at least some implementations, the signals 202a, 202b are separately received at the endpoint device 104 and combined at the endpoint device 104 to generate an integrated data stream. Alternatively, the signals 202a, 202b are combined by a network component 110 into a single signal that is then forwarded to the endpoint device 104 as an integrated data stream. In either case, the endpoint device demodulates and decodes data from the combined signals 202a, 202b to reveal media data of the communication session, such as voice data, video data, content sharing data, and so forth.

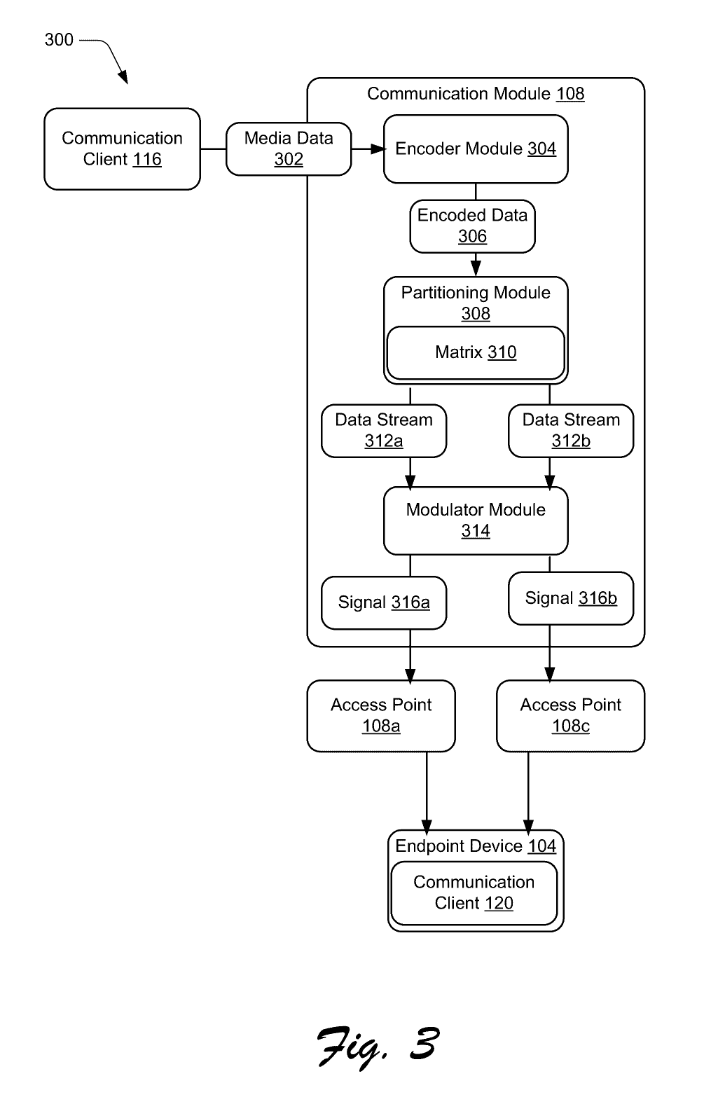

FIG. 3 depicts an example implementation scenario 300 for generating separate signals for media data of a communication session in accordance with one or more implementations. The scenario 300, for instance, depicts an example way of generating the signals 202a, 202b described above. In this particular example, aspects of the scenario 300 are performed by components of the communication module 118. This is not intended to be limiting, however, and aspects of the scenario 300 may be performed by a variety of other functionalities and/or entities in accordance with the claimed implementations.

In the scenario 300, media data 302 is generated for a communication session. For instance, the media data 302 is generated in response to user interaction with the communication client 116. The media data 302 communicated to an encoder module 304, which encodes the media data 302 to generate encoded data 306. According to various implementations, the encoder module 304 applies any suitable type of error encoding algorithm to the media data 302 to generate the encoded data 306, such as Forward Error Correction (FEC). Thus, encoding the media data 302 causes redundant bits to be introduced into the media data 302 to generate the encoded data 304.

The encoded data 304 is then communicated to a partitioning module 308, which applies a partitioning matrix 310 to the encoded data 306 to generate a data stream 312a and a data stream 312b. Generally, applying the partitioning matrix 310 splits the encoded data 306 into multiple data streams to generate the data streams 312a, 312b. The partitioning algorithm may be implemented in various ways, such as a puncturing matrix that punctures the data stream of the encoded data 306 to generate the data streams 312a, 312b. As further detailed below, the partitioning matrix 310 may be selected based on various criteria, such as to increase an error correction robustness of the data streams 312a, 312b, to account for variations in performance attributes across different APs, and so forth.

In at least some implementations, the data streams 312a, 312b may be asymmetrical, e.g., may include different respective arrangements and/or collections of bits. For instance, the data stream 312a may include more bits than the data stream 312b, such as to provide more data redundancy within the data stream 312a than within the data stream 312b. Generally, increasing data redundancy increases the ability of a receiving device to correctly decode data included in the data stream 312a.

The data streams 312a, 312b are communicated to a modulator module 314, which separately modulates the data streams to generate a modulated signal 316a for the data stream 312a, and a modulated signal 316b for the data stream 312b. Generally, the signals 316a, 316b included data from the respective data streams 312a, 312b in a modulated form, e.g., as passband signals. In at least some implementations, the signals 316a, 316b represent the signals 202a, 202b, respectively, discussed above.

The signals 316a, 316b are then transmitted to the respective APs 108a, 108c, which then forward the signals 316a, 316b for receipt by the endpoint device 104. As further detailed below, the signals 316a, 316b are combined at the endpoint device 104 or at an intermediate component to generate an integrated media stream as part of a communication session.

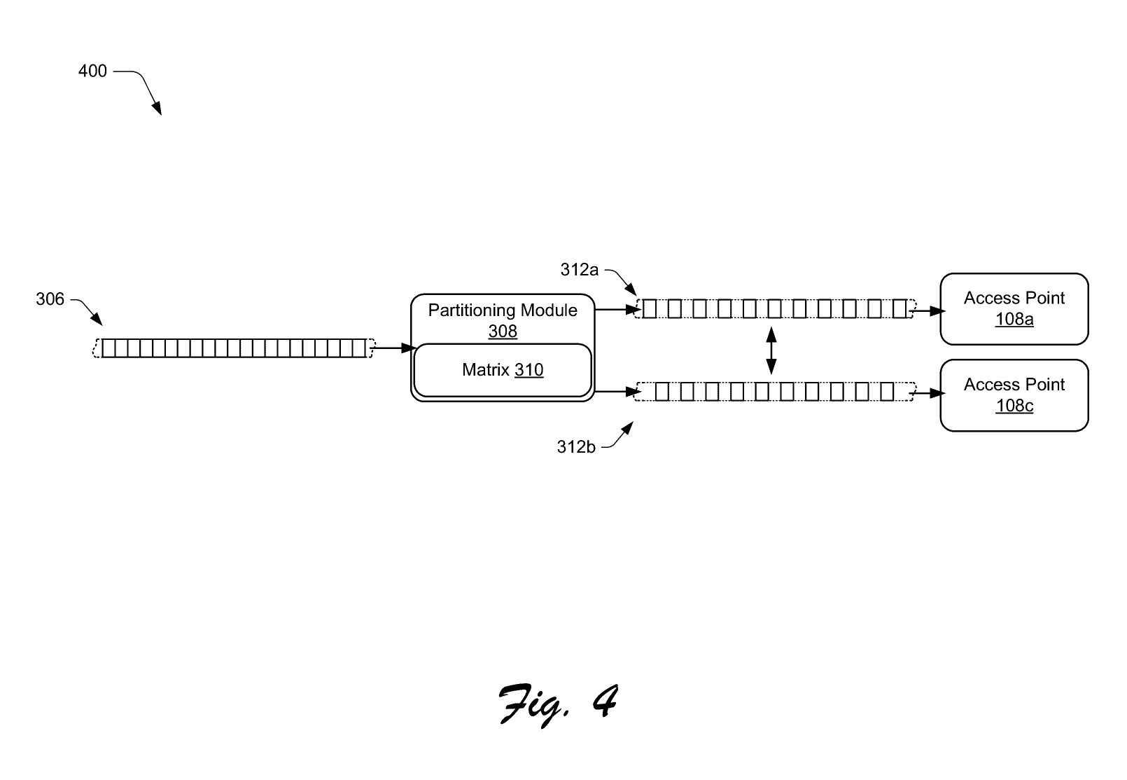

FIG. 4 depicts an example implementation scenario 400 for partitioning a data stream in accordance with one or more implementations. The scenario 400, for instance, depicts an example way of generating the data streams 312a, 312b described above.

In the scenario 400, the encoded data 306 is received at the partitioning module 308. Generally, the encoded data 306 represents media data of a communication session that has been encoded, such as using FEC to introduce redundancy into the media data. The encoded data 306, for instance, represents a stream of encoded blocks of data, such as code words generated by the encoder module 304 by encoding the media data 302.

The partitioning module 308 applies the partitioning matrix 310 to the encoded data 306 to generate the data stream 312a and the data stream 312b. In this particular example, applying the partitioning matrix 310 causes alternate portions (e.g., bits) of the encoded data 306 to be removed (e.g., punctured) to generate the data streams 312a, 312b. For instance, every other bit of the encoded data 306 is used to generate the data stream 312b, with the remaining bits representing the data stream 312a. The data streams 312a, 312b can then be modulated and transmitted wirelessly to the respective APs 108a, 108c for forwarding to the endpoint device 104.

In at least some implementations, the scenario 400 represents an implementation where the APs 108a, 108c are considered to have a similar signal quality, e.g., ability to receive wireless transmission from the client device 102, and to forward data from the wireless transmission to a receiving device with an acceptable level of fidelity. Thus, the data streams 312a, 312b are generated to include a similar (e.g., same) level of redundancy.

Alternatively or additionally, the data streams 312a, 312b are generated to maximize a Hamming distance between the data streams 312a, 312b. For instance, the partitioning matrix 310 is generated to cause partitioning of the encoded data 306 to maximize Hamming distance between the data streams 312a, 312b. Generally, maximizing the Hamming distance increases an ability of a receiving device to correctly decode data transmitted from the data streams 312a, 312b. Alternatively or additionally, other criteria may be considered in partitioning the encoded data 306, such as maximizing the Euclidean distance between the data streams 312a, 312b, accounting for variations in AP attributes, and so forth. For instance, consider the following implementation scenario.

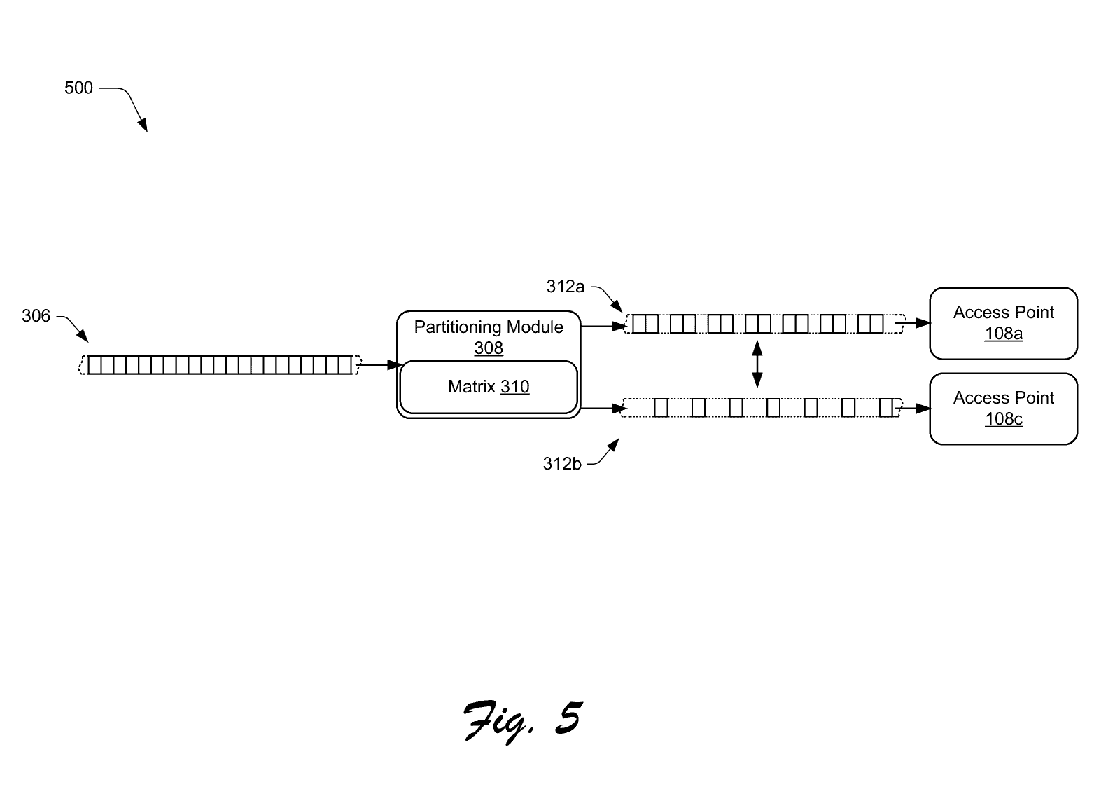

FIG. 5 depicts an example implementation scenario 500 for partitioning a data stream in accordance with one or more implementations. The scenario 500, for instance, depicts an example way of generating the data streams 312a, 312b described above. For example, the scenario 500 describes an alternate or additional scenario to the scenario 400 described above.

In the scenario 500, the encoded data 306 is received at the partitioning module 308. The partitioning module 308 applies the partitioning matrix 310 to the encoded data 306 to generate the data stream 312a and the data stream 312b. In this particular example, applying the partitioning matrix 310 causes every Nth bit of the encoded data 306 to be removed (e.g., punctured) to generate the data streams 312a, 312b, where N>2. For instance, every third bit of the encoded data 306 is used to generate the data stream 312b, with the remaining bits representing the data stream 312a. The data streams 312a, 312b can then be modulated and transmitted wirelessly to the respective APs 108a, 108c for forwarding to the endpoint device 104.

According to various implementations, the partitioning matrix 310 is applied to the encoded data to increase a distance between the data streams 312a, 312b, such as a Hamming distance, a Euclidean distance, and so forth.

Alternatively or additionally, the partitioning matrix 310 is applied based on attributes of the APs 108a, 108c. For instance, consider that the AP 108a is determined to have a lower signal quality than the AP 108c for forwarding data received from the client device 102. For instance, the AP 108a is historically known to have a lower signal quality for signal forwarded from the AP 108a. This may be due to various factors, such as interference (e.g., radio frequency (RF) interference, physical interference, and so forth) between the client device 102 and the AP 108a, a physical distance between the client device 102 and the AP 108a, lower transmission power utilized by the AP 108a, and so forth. Accordingly, the partitioning matrix 310 is generated to include more data redundancy in the data stream 312a than in the data stream 312b. Thus, the endpoint device 104 will receive more redundant bits in the data stream 312a with which to attempt to decode the data stream 312a.

While the scenarios 400, 500 are discussed with reference to partitioning a data stream by puncturing bits at regular intervals, it is to be appreciated that implementations can be employed to partitioning a data stream by puncturing bits at irregular intervals. Consider, for instance, the following example implementation scenario.

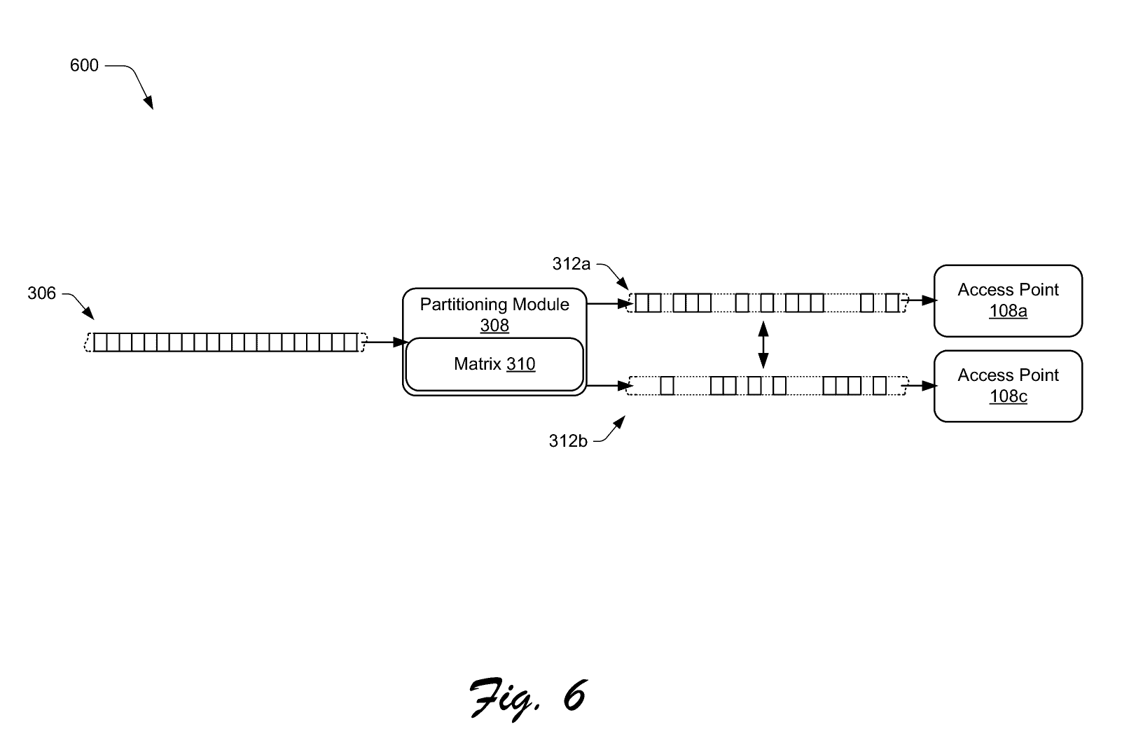

FIG. 6 depicts an example implementation scenario 600 for partitioning a data stream in accordance with one or more implementations. The scenario 600, for instance, depicts an example way of generating the data streams 312a, 312b described above. For example, the scenario 600 describes an alternate or additional scenario to the scenarios 400, 500 described above.

In the scenario 600, the encoded data 306 is received at the partitioning module 308. The partitioning module 308 applies the partitioning matrix 310 to the encoded data 306 to generate the data stream 312a and the data stream 312b. In this particular example, applying the partitioning matrix 310 causes the encoded data 306 to be punctured at irregular intervals to generate the data streams 312a, 312b. For instance, the encoded data 306 is punctured at irregular intervals to generate the data stream 312b, with the remaining bits representing the data stream 312a. The data streams 312a, 312b can then be modulated and transmitted wirelessly to the respective APs 108a, 108c for forwarding to the endpoint device 104.

In at least some implementations, the partitioning matrix 310 is applied to the encoded data to increase a distance between the data streams 312a, 312b, such as a Hamming distance, a Euclidean distance, and so forth.

According to one or more implementations, a particular scenario of the scenarios 400-600 may be implemented based on conditions that apply to a particular communication session, such as attributes of APs that are available to route data of the communication session. Alternatively or additionally, the implementation scenarios may be utilized together to accommodate changes that occur during a communication session. For instance, consider that when a communication session is initiated, encoded data of the communication session is partitioned and transmitted according to the scenario 400. However, while the communication session is in progress, a variation (e.g., reduction) in signal quality for an AP occurs during the communication session. Accordingly, and in response to the variation in signal quality, partitioning of encoded data switches to one or more of the scenarios 500, 600 to increase a redundancy of encoded data received at the affected AP, and/or to increase a Hamming distance between data streams partitioned from the encoded data. Thus, techniques discussed herein can dynamically configure and reconfigure a partitioning scheme to respond to various events that may occur during a communication session.

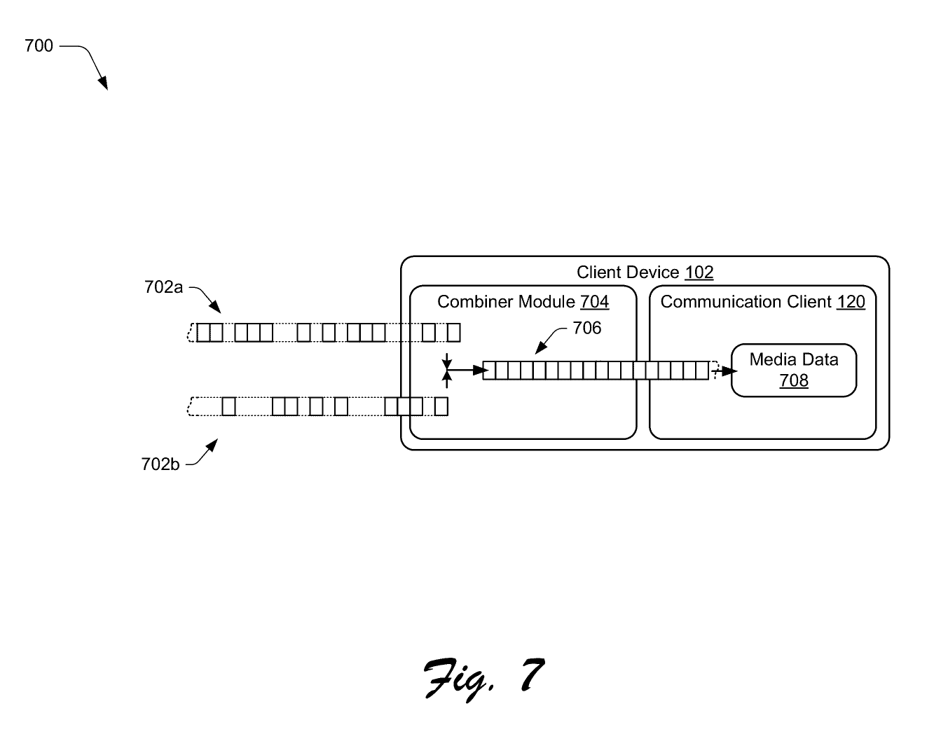

FIG. 7 depicts an example implementation scenario 700 for combining data transmitted in separate signals in accordance with one or more implementations. The scenario 700, for instance, depicts an example way of combining data from the data streams 312a, 312b described above. For example, the scenario 700 describes an extension of one or more of the scenarios described above.

In the scenario 700, data streams 702a, 702b are received at the endpoint device 104 as separate data streams. For instance, the endpoint device 104 receives the wireless signals 316a, 316b as separate signals and demodulates and decodes the signals 316a, 316b to generate the data streams 702a, 702b. A combiner module 704 of the endpoint device 104 then combines the data streams 702a, 702b to generate a combined data stream 706 that is processed by the communication client 120 to generate media data 708. The media data 708, for instance, recreates at least some of the media data 302. The communication client 120 can then cause the media data 708 to be output as part of a communication session. For instance, the media data 708 includes audio, video, and/or other content generated at the client device 102 as part of a real-time communication session between the client device 102 and the endpoint device 104.

According to various implementations, the combiner module 704 represents functionality for combining different data streams. For instance, the client device 102 informs the combiner module 704 of a partitioning matrix utilized to generate the data streams 702a, 702b. Thus, combiner module 704 may combine the data streams 702a, 702b based on the partitioning matrix to generate the combined data stream 706.

The combiner module 704 may be implemented in various ways. For instance, the combiner module 704 may be implemented as part of a wireless driver of the endpoint device 104. Alternatively or additionally, the combiner module 704 may be implemented at an application level and/or application layer of the endpoint device 104, such as a functionality of the communication client 120, a functionality of an over-the-top application, and so forth.

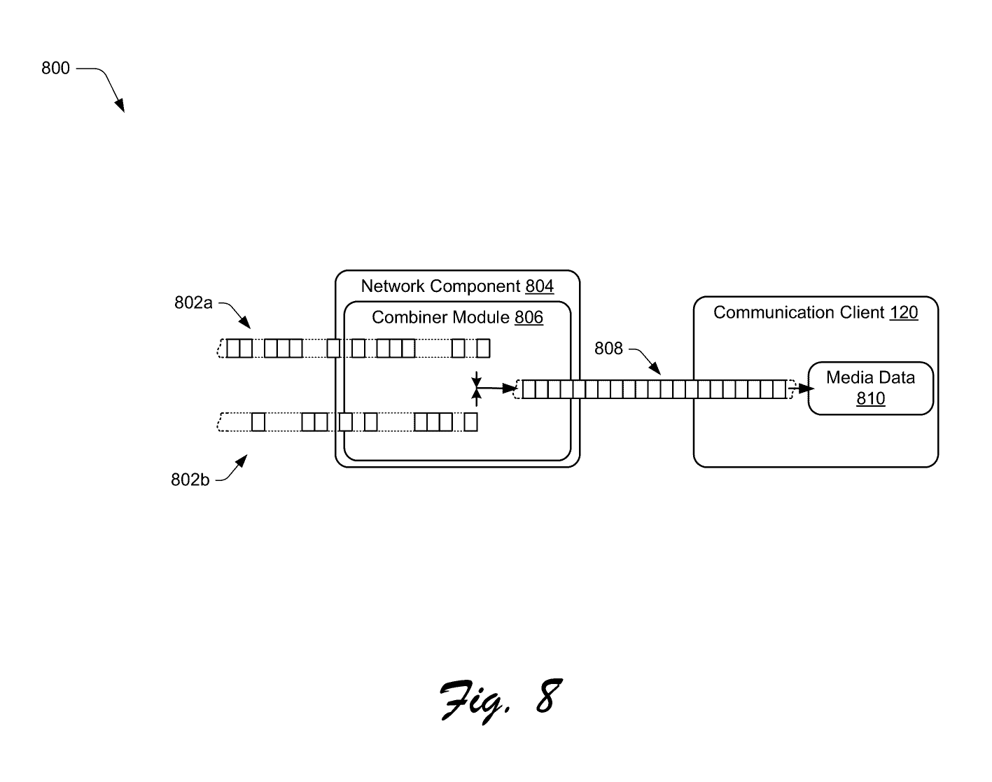

FIG. 8 depicts an example implementation scenario 800 for combining data transmitted in separate signals in accordance with one or more implementations. The scenario 800, for instance, depicts an example way of combining data from the data streams 312a, 312b described above. For example, the scenario 800 describes an extension of one or more of the scenarios described above.

In the scenario 800, data streams 802a, 802b are received at a network component 804. The network component 804, for example, represents an instance of the network components 110 described with reference to the environment 100. A combiner module 806 of the network component 804 then combines the data streams 802a, 802b to generate a combined data stream 808, and forwards the combined data stream 808 to the communication client 120. The combiner module 806 is representative of functionality for combining different data streams. For instance, the client device 102 informs the combiner module 806 of a partitioning matrix utilized to generate the data streams 802a, 802b. Thus, combiner module 806 may combine the data streams 802a, 802b based on the partitioning matrix to generate the combined data stream 808.

The communication client 120 processes the combined data stream 808 to generate media data 810. The media data 810, for instance, recreates at least some of the media data 302. The communication client 120 can then cause the media data 810 to be output as part of a communication session. For instance, the media data 810 includes audio, video, and/or other content generated at the client device 102 as part of a real-time communication session between the client device 102 and the endpoint device 104.

Thus, the scenarios 700, 800 describe implementations where media data transmitted via separate signals can be combined at a receiving endpoint device, and/or at an intermediate component.

Having discussed some example implementation scenarios, consider now a discussion of some example procedures in accordance with one or more embodiments.

Example Procedures

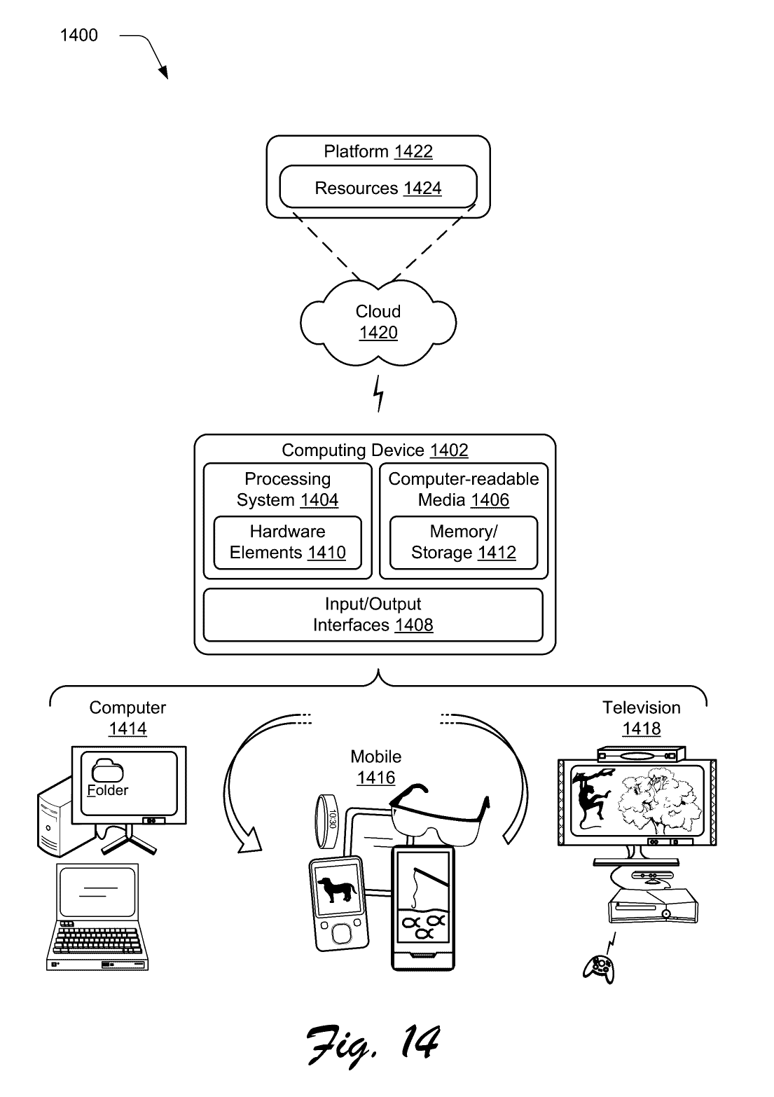

The following discussion describes some example procedures for partitioning media data in accordance with one or more embodiments. The example procedures may be employed in the environment 100 of FIG. 1, the system 1400 of FIG. 14, and/or any other suitable environment. The procedures, for instance, represent procedures for implementing the example implementation scenarios discussed above. In at least some embodiments, the steps described for the various procedures can be implemented automatically and independent of user interaction.

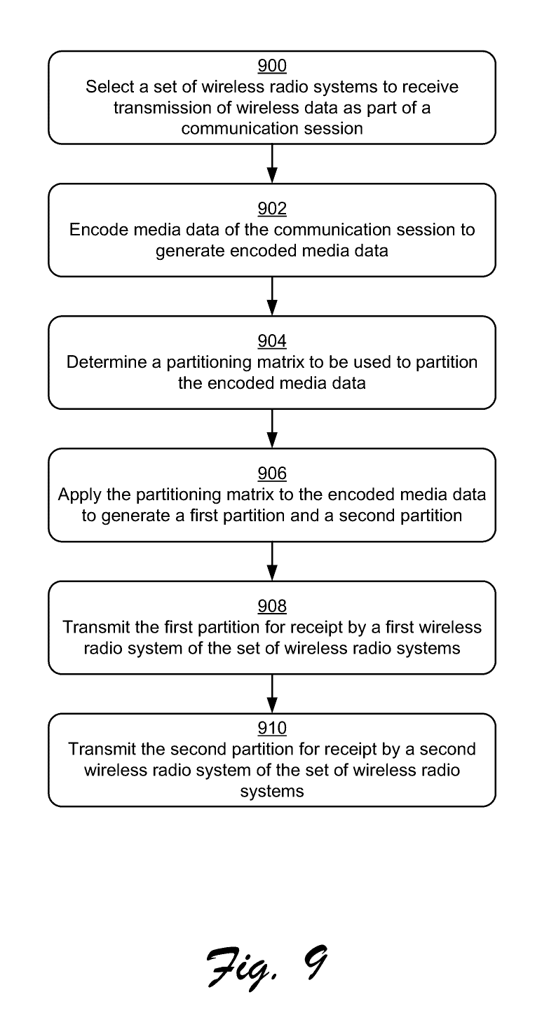

FIG. 9 is a flow diagram that describes steps in a method in accordance with one or more embodiments. The method describes an example procedure for partitioning data of a communication session in accordance with one or more embodiments.

Step 900 selects a set of wireless radio systems to receive transmission of wireless data as part of a communication session. Generally, a wireless radio system represents functionality for receiving wireless transmission of data, and for forwarding the data to one or more entities. Examples of a wireless radio system include a Wi-Fi™ access point, a wireless cellular base station, a client device serving as an access point for another client device, and so forth. The client device 102, for instance, detects signal from the APs 108 indicating that the APs 108 are available for communicating data wirelessly to and from the client device 102. The client device 102 selects a set of wireless APs from the APs 108 based on various criteria. Example ways of selecting APs for receiving data transmission are discussed below.

Step 902 encodes media data of the communication session to generate encoded media data. The communication module 118, for example, applies error correction coding to the media data to generate the encoded media data, such as using one or more FEC techniques.

Step 904 determines a partitioning matrix to be used to partition the encoded media data. For instance, the partitioning matrix is determined based on various attributes, such as a number of APs to be used, quality and/or signal strength attributes of the APs, robustness of error correction, and so forth. Example ways of selecting a partitioning matrix are discussed below.

Step 906 applies the partitioning matrix to the encoded media data to generate a first partition and a second partition. In at least some implementations, the partitions each include different respective portions of the encoded media data. For instance, the first partition may include data that is redundant with data of the second partition, and may include data that is not redundant with data of the second partition. Alternatively, the first partition and second partition may include redundant data. In at least some implementations, the first partition has a different code rate (e.g., amount of redundant data) than the second partition.

Step 908 transmits the first partition for receipt by a first wireless radio system of the set of wireless radio systems. The first partition, for example, is transmitted by the client device 102 to a first AP 108 for forwarding to the endpoint device 104 as part of the communication session.

Step 910 transmits the second partition for receipt by a second wireless radio system of the set of wireless radio systems. The second partition, for example, is transmitted by the client device 102 to a second AP 108 for forwarding to the endpoint device 104 as part of the communication session.

While this procedure is described with reference to two different partitions of encoded data, it is to be appreciated that implementations discussed herein may utilize more than two partitions. For instance, n APs may be selected to receive wireless transmission of data of a communication session, where n>2. In such a scenario, a stream of encoded media data may be partitioned into n partitions and each of the n partitions is transmitted to a different AP for forwarding to a single endpoint device involved in the communication session.

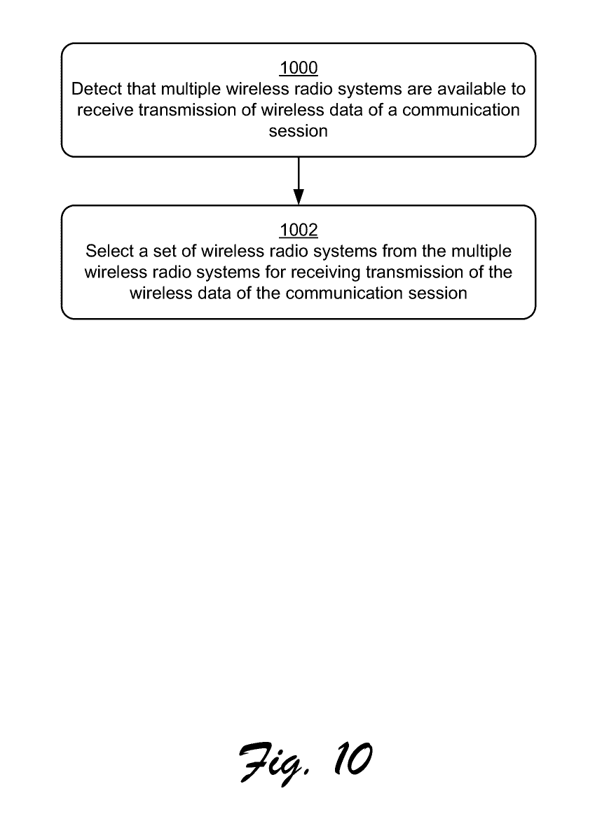

FIG. 10 is a flow diagram that describes steps in a method in accordance with one or more embodiments. The method describes an example procedure for selecting APs for wireless transmission of data of a communication session in accordance with one or more embodiments.

Step 1000 detects that multiple wireless radio systems are available to receive transmission of wireless data of a communication session. The client device 102, for instance, detects wireless signal (e.g. beacon frames) transmitted from multiple APs 108 at a particular location.

Step 1002 selects a set of wireless radio systems from the multiple wireless radio systems for receiving transmission of the wireless data of the communication session. A selected set of APs, for instance, does not include all of the detected available APs, e.g., is a subset of the available APs. Generally, the set of APs can be selected in various ways. For instance, the connection manager 122 can match identifiers for the available APs to the client AP DB 124, and select a set of preferred APs from the multiple available APs.

As another option, the client device 102 can query the communication service 128 with its location, such as Global Positioning System (GPS) coordinates, physical address, and so forth. The communication service 128 queries the service AP DB 130 with the location and selects a set of preferred APs that are available at the location. The communication service 128 then returns identifiers for the set of preferred APs to the client device 102, which utilizes the preferred APs for wireless data transmission.

As yet a further option, the client device 102 can query the available APs for indicia of signal quality, and a set of APs that are indicated as having the highest signal quality are selected.

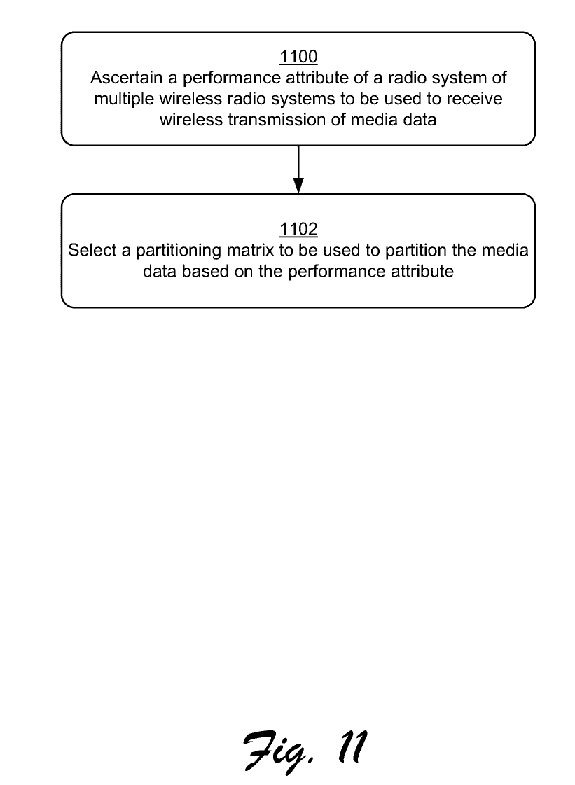

FIG. 11 is a flow diagram that describes steps in a method in accordance with one or more embodiments. The method describes an example procedure for selecting a partitioning matrix based on attributes of an access point in accordance with one or more embodiments.

Step 1100 ascertains a performance attribute of a radio system of multiple wireless radio systems to be used to receive wireless transmission of media data. The media data, for instance, represents a media stream of a communication session. For example, the connection manager 122 ascertains a performance attribute for an AP 108 to be used to receive wireless data transmission as part of a communication session. Generally, performance attributes for APs may be specified in the client AP DB 124 and/or the service AP DB 130.

In at least some implementations, the performance attribute includes an indication of AP performance quality. The performance attribute, for instance, identifies whether the AP is known to meet a quality threshold. Alternatively or additionally, the performance attribute indicates whether the AP is identified as being low quality, acceptable quality, or high quality. For example, the performance attribute provides an indication of signal quality for the AP that can be compared to quality attributes of other APs to determine quality of the APs relative to one another.

Alternatively or additionally, the performance attribute includes an indication of AP capability, such as bandwidth capability, transmission range, supported wireless protocols, and so forth.

Step 1102 selects a partitioning matrix to be used to partition the media data based on the performance attribute. For instance, the performance attribute is compared to a performance attribute of a different AP of the multiple APs. If the performance attribute indicates that the AP has a lower quality and/or reduced capability (e.g., bandwidth and/or range) compared to the different AP, a partitioning matrix is selected to provide a higher data redundancy to the AP than to the different AP. If the performance attribute indicates that the AP has a higher quality and/or enhanced capability (e.g., bandwidth and/or range) compared to the different AP, a partitioning matrix is selected to provide a lower data redundancy to the AP than to the different AP. Alternatively, if the performance attribute indicates that the AP has a similar quality and/or similar capability (e.g., bandwidth and/or range) compared to the different AP, a partitioning matrix is selected to provide a similar (e.g., same) data redundancy to the AP than to the different AP.

According to various implementations, a matrix can be selected by the connection manager 122 from the client matrix DB 126, such as by selecting a partitioning matrix specified for a particular AP performance attribute. Alternatively or additionally, the connection manager 122 can query the communication service 128 with the performance attribute, and the communication service 128 can query the service matrix DB 132 with the performance attribute to identify a suitable partitioning matrix. The communication service 128 can then return the partitioning matrix to the client device 102.

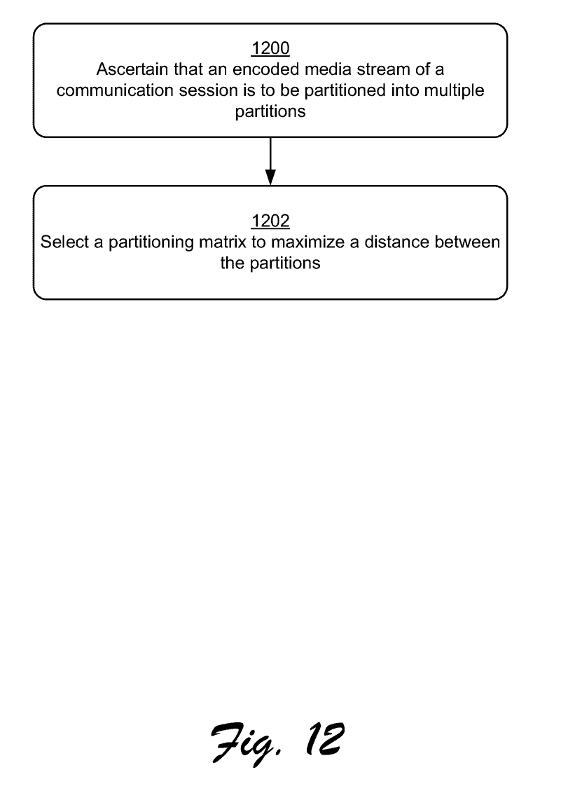

FIG. 12 is a flow diagram that describes steps in a method in accordance with one or more embodiments. The method describes an example procedure for selecting a partitioning matrix to maximize distance between media streams in accordance with one or more embodiments.

Step 1200 ascertains that an encoded media stream of a communication session is to be partitioned into multiple partitions. The connection manager 122, for instance, selects multiple APs for receiving wireless transmission of media data from the client device 102 as part of a communication session. Example ways for selecting APs are discussed above. The connection manager 122 then ascertains that the encoded media stream is to be partitioned to generate different partitions that are to be individually transmitted to a different AP as part of the communication session.

Step 1202 selects a partitioning matrix to maximize a difference between the partitions. The difference, for example, represents a distance between the partitions, such as a difference between code words and/or bits included in the respective partitions. The difference may be specified in various ways, such as Hamming distance, Euclidean distance, and so forth. Generally, increasing the distance between partitions increases the ability of a receiving device to correctly decode media data included in the partitions.

According to various implementations, the partitioning matrix is implemented as a puncturing matrix that punctures the encoded media stream to generate different partitions.

In at least some implementations, a partitioning matrix can be selected by the connection manager 122 from the client matrix DB 126, such as by selecting a partitioning matrix identified in the client matrix DB as being applicable to maximize a distance between a particular number of partitions. Alternatively or additionally, the connection manager 122 can query the communication service 128 for a partitioning matrix, and the communication service 128 can query the service matrix DB 132 for a partitioning matrix for maximizing distance between a number of partitions. The communication service 128 can then return the partitioning matrix to the client device 102.

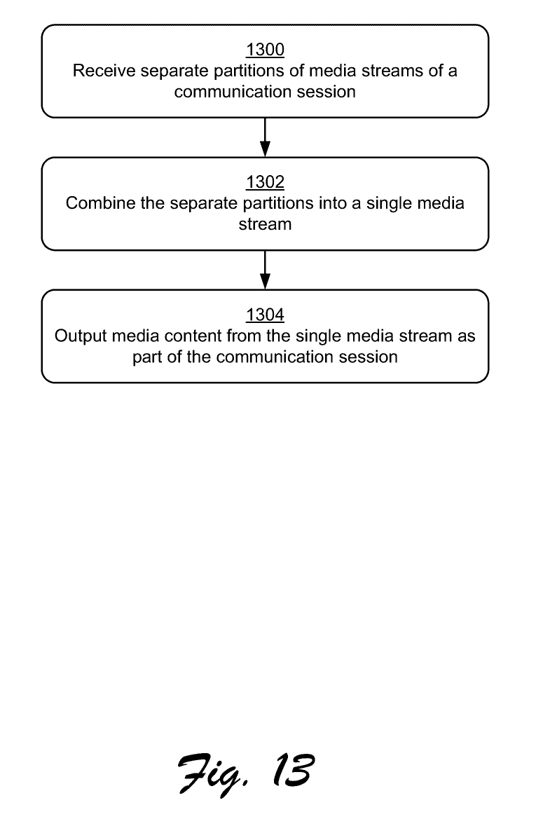

FIG. 13 is a flow diagram that describes steps in a method in accordance with one or more embodiments. The method describes an example procedure for combining media streams in accordance with one or more embodiments. The method, for instance, may be performed by one or more the combiner module 704 or the combiner module 806, discussed above.

Step 1300 receives separate partitions of media data of a communication session. The endpoint device 104, for example, receives separate streams of encoded media data as part of a communications session. Alternatively, a network component 110 receives separate streams of encoded media data.

Step 1302 combines the separate partitions into a single media stream. The endpoint device 104, for example, combines the separate streams into a combined stream of encoded media data. Alternatively, a network component 110 combines the separate streams into a combined stream of encoded media data.

Step 1304 outputs media content from the single media stream as part of the communication session. The endpoint device 104, for instance, decodes data from the media stream and outputs media content included in the data, such as voice, video, content, and so forth.

Having discussed some example procedures, consider now a discussion of an example system and device in accordance with one or more embodiments.

Example System and Device

FIG. 14 illustrates an example system generally at 1400 that includes an example computing device 1402 that is representative of one or more computing systems and/or devices that may implement various techniques described herein. For example, the client device 102 and/or the endpoint device 104 discussed above with reference to FIG. 1 can be embodied as the computing device 1402. The computing device 1402 may be, for example, a server of a service provider, a device associated with the client (e.g., a client device), an on-chip system, and/or any other suitable computing device or computing system.

The example computing device 1402 as illustrated includes a processing system 1404, one or more computer-readable media 1406, and one or more Input/Output (I/O) Interfaces 1408 that are communicatively coupled, one to another. Although not shown, the computing device 1402 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 1404 is representative of functionality to perform one or more operations using hardware. Accordingly, the processing system 1404 is illustrated as including hardware element 1410 that may be configured as processors, functional blocks, and so forth. This may include implementation in hardware as an application specific integrated circuit or other logic device formed using one or more semiconductors. The hardware elements 1410 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable media 1406 is illustrated as including memory/storage 1412. The memory/storage 1412 represents memory/storage capacity associated with one or more computer-readable media. The memory/storage 1412 may include volatile media (such as random access memory (RAM)) and/or nonvolatile media (such as read only memory (ROM), Flash memory, optical disks, magnetic disks, and so forth). The memory/storage 1412 may include fixed media (e.g., RAM, ROM, a fixed hard drive, and so on) as well as removable media (e.g., Flash memory, a removable hard drive, an optical disc, and so forth). The computer-readable media 1406 may be configured in a variety of other ways as further described below.

Input/output interface(s) 1408 are representative of functionality to allow a user to enter commands and information to computing device 1402, and also allow information to be presented to the user and/or other components or devices using various input/output devices. Examples of input devices include a keyboard, a cursor control device (e.g., a mouse), a microphone (e.g., for voice recognition and/or spoken input), a scanner, touch functionality (e.g., capacitive or other sensors that are configured to detect physical touch), a camera (e.g., which may employ visible or non-visible wavelengths such as infrared frequencies to detect movement that does not involve touch as gestures), and so forth. Examples of output devices include a display device (e.g., a monitor or projector), speakers, a printer, a network card, tactile-response device, and so forth. Thus, the computing device 1402 may be configured in a variety of ways as further described below to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on or transmitted across some form of computer-readable media. The computer-readable media may include a variety of media that may be accessed by the computing device 1402. By way of example, and not limitation, computer-readable media may include “computer-readable storage media” and “computer-readable signal media.”

“Computer-readable storage media” may refer to media and/or devices that enable persistent storage of information in contrast to mere signal transmission, carrier waves, or signals per se. Computer-readable storage media do not include signals per se. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” may refer to a signal-bearing medium that is configured to transmit instructions to the hardware of the computing device 1402, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, radio frequency (RF), infrared, and other wireless media.

As previously described, hardware elements 1410 and computer-readable media 1406 are representative of instructions, modules, programmable device logic and/or fixed device logic implemented in a hardware form that may be employed in some embodiments to implement at least some aspects of the techniques described herein. Hardware elements may include components of an integrated circuit or on-chip system, an application-specific integrated circuit (ASIC), a field-programmable gate array (FPGA), a complex programmable logic device (CPLD), and other implementations in silicon or other hardware devices. In this context, a hardware element may operate as a processing device that performs program tasks defined by instructions, modules, and/or logic embodied by the hardware element as well as a hardware device utilized to store instructions for execution, e.g., the computer-readable storage media described previously.

Combinations of the foregoing may also be employed to implement various techniques and modules described herein. Accordingly, software, hardware, or program modules and other program modules may be implemented as one or more instructions and/or logic embodied on some form of computer-readable storage media and/or by one or more hardware elements 1410. The computing device 1402 may be configured to implement particular instructions and/or functions corresponding to the software and/or hardware modules. Accordingly, implementation of modules that are executable by the computing device 1402 as software may be achieved at least partially in hardware, e.g., through use of computer-readable storage media and/or hardware elements 1410 of the processing system. The instructions and/or functions may be executable/operable by one or more articles of manufacture (for example, one or more computing devices 1402 and/or processing systems 1404) to implement techniques, modules, and examples described herein.

As further illustrated in FIG. 14, the example system 1400 enables ubiquitous environments for a seamless user experience when running applications on a personal computer (PC), a television device, and/or a mobile device. Services and applications run substantially similar in all three environments for a common user experience when transitioning from one device to the next while utilizing an application, playing a video game, watching a video, and so on.

In the example system 1400, multiple devices are interconnected through a central computing device. The central computing device may be local to the multiple devices or may be located remotely from the multiple devices. In one embodiment, the central computing device may be a cloud of one or more server computers that are connected to the multiple devices through a network, the Internet, or other data communication link.

In one embodiment, this interconnection architecture enables functionality to be delivered across multiple devices to provide a common and seamless experience to a user of the multiple devices. Each of the multiple devices may have different physical requirements and capabilities, and the central computing device uses a platform to enable the delivery of an experience to the device that is both tailored to the device and yet common to all devices. In one embodiment, a class of target devices is created and experiences are tailored to the generic class of devices. A class of devices may be defined by physical features, types of usage, or other common characteristics of the devices.

In various implementations, the computing device 1402 may assume a variety of different configurations, such as for computer 1414, mobile 1416, and television 1418 uses. Each of these configurations includes devices that may have generally different constructs and capabilities, and thus the computing device 1402 may be configured according to one or more of the different device classes. For instance, the computing device 1402 may be implemented as the computer 1414 class of a device that includes a personal computer, desktop computer, a multi-screen computer, laptop computer, netbook, and so on.

The computing device 1402 may also be implemented as the mobile 1416 class of device that includes mobile devices, such as a mobile phone, portable music player, portable gaming device, a tablet computer, a multi-screen computer, wearable devices, and so on. The computing device 1402 may also be implemented as the television 1418 class of device that includes devices having or connected to generally larger screens in casual viewing environments. These devices include televisions, set-top boxes, gaming consoles, and so on.

The techniques described herein may be supported by these various configurations of the computing device 1402 and are not limited to the specific examples of the techniques described herein. For example, functionalities discussed with reference to the entities of the environment 100 may be implemented all or in part through use of a distributed system, such as over a “cloud” 1420 via a platform 1422 as described below.

The cloud 1420 includes and/or is representative of a platform 1422 for resources 1424. The platform 1422 abstracts underlying functionality of hardware (e.g., servers) and software resources of the cloud 1420. The resources 1424 may include applications and/or data that can be utilized while computer processing is executed on servers that are remote from the computing device 1402. Resources 1424 can also include services provided over the Internet and/or through a subscriber network, such as a cellular or Wi-Fi network.

The platform 1422 may abstract resources and functions to connect the computing device 1402 with other computing devices. The platform 1422 may also serve to abstract scaling of resources to provide a corresponding level of scale to encountered demand for the resources 1424 that are implemented via the platform 1422. Accordingly, in an interconnected device embodiment, implementation of functionality described herein may be distributed throughout the system 1400. For example, the functionality may be implemented in part on the computing device 1402 as well as via the platform 1422 that abstracts the functionality of the cloud 1420.

Discussed herein are a number of methods that may be implemented to perform techniques discussed herein. Aspects of the methods may be implemented in hardware, firmware, or software, or a combination thereof. The methods are shown as a set of steps that specify operations performed by one or more devices and are not necessarily limited to the orders shown for performing the operations by the respective blocks. Further, an operation shown with respect to a particular method may be combined and/or interchanged with an operation of a different method in accordance with one or more implementations. Aspects of the methods can be implemented via interaction between various entities discussed above with reference to the environment 100.

Implementations discussed herein include:

### Example 1

A system for partitioning data of a communication session, the system including: at least one processor; and one or more computer-readable storage media including instructions stored thereon that, responsive to execution by the at least one processor, cause the system perform operations including: encoding media data of a communication session to generate encoded media data; applying a partitioning matrix to the encoded media data to generate a first partition and a second partition that each include different respective portions of the encoded media data; transmitting the first partition for receipt by a first wireless radio system and for forwarding to a device as part of the communication session; and transmitting the second partition for receipt by a second wireless radio system and for forwarding to the device as part of the communication session.

### Example 2

A system as described in example 1, wherein said applying the partitioning matrix punctures the encoded media stream to generate the first partition and the second partition.

### Example 3

A system as described in one or more of examples 1 or 2, wherein said encoding causes the encoded media data to include redundant data, and wherein said applying the partitioning matrix causes the first partition to have a different amount of redundant data then the second partition.

### Example 4

A system as described in one or more of examples 1-3, wherein said applying the partitioning matrix causes the first partition to have a different code rate then the second partition.

### Example 5

A system as described in one or more of examples 1-4, wherein the operations further include selecting the partitioning matrix to maximize a Hamming distance between the first partition and the second partition.

### Example 6

A system as described in one or more of examples 1-5, wherein the partitioning matrix is variable based on a detected signal quality for one or more of the first wireless radio system or the second wireless radio system.

### Example 7

A system as described in one or more of examples 1-6, wherein the operations further include: ascertaining that the first wireless radio system has a lower performance attribute than the second wireless radio system; and selecting, responsive to said ascertaining, the partitioning matrix to provide a higher data redundancy in the first partition than in the second partition.

### Example 8

A system as described in one or more of examples 1-7, wherein the device includes one or more of an endpoint device, a network component, or an application residing on an endpoint device.

### Example 9

A system as described in one or more of examples 1-8, wherein the operations further include, prior to transmitting the first partition and the second partition: detecting multiple wireless radio systems that are available; and selecting the first wireless radio system and the second wireless radio system as a subset of the multiple wireless radio systems and based on a performance attribute of one or more of the first wireless radio system or the second wireless radio system.

### Example 10

A system as described in one or more of examples 1-9, wherein the operations further include, prior to transmitting the first partition and the second partition: detecting multiple wireless radio system that are available; and selecting one or more of the first wireless radio system or the second wireless radio system as a subset of the multiple wireless radio systems and based on one or more of the first wireless radio system or the second wireless radio system being identified as a preferred wireless radio system.

### Example 11

A computer-implemented method for partitioning data of a communication session, the method including: detecting that multiple wireless radio systems are available to receive wireless transmission of encoded media data of a communication session; selecting a first wireless radio system and a second wireless radio system from the multiple wireless radio systems and based on one or more criteria for selecting a wireless radio system; applying a partitioning matrix to the encoded media data to generate a first partition and a second partition that each include different respective portions of the encoded media data; transmitting the first partition for receipt by the first wireless radio system for forwarding to a device as part of the communication session; and transmitting the second partition for receipt by the second wireless radio system for forwarding to the device as part of the communication session.

### Example 12

A method as described in example 11, further including ascertaining that the one or more of the first wireless radio system or the second wireless radio system are indicated in an radio system database as a preferred wireless radio system.

### Example 13

A method as described in one or more of examples 11 or 12, further including selecting the partitioning matrix to maximize a Hamming distance between the first partition and the second partition.

### Example 14

A method as described in one or more of examples 11-13, further including selecting the partitioning matrix based on a performance attributes of one or more of the first wireless radio system or the second wireless radio system.

### Example 15

A method as described in one or more of examples 11-14, wherein the one or more attributes indicate that the first wireless radio system has a lower performance attribute than the second wireless radio system, and wherein said determining includes determining the partitioning matrix to provide a higher data redundancy in the first partition than in the second partition.

### Example 16

A computer-implemented method for combining data of a communication session, the method including: receiving separate partitions of media data of a communication session from different wireless radio systems, the separate partitions transmitted from a single client device; and combining the separate partitions into a single media stream for output at an endpoint device as media content of the communication session.

### Example 17

A computer-implemented method as described in example 16, wherein said combining is performed at a network component prior to being received by the endpoint device.

### Example 18

A computer-implemented method as described in one or more of examples 16 or 17, wherein said combining is performed at a wireless network controller prior to being received by the endpoint device.

### Example 19

A computer-implemented method as described in one or more of examples 16-18, wherein said combining is performed at a wireless driver level of the endpoint device.

### Example 20

A computer-implemented method as described in one or more of examples 16-19, wherein said combining is performed at an application of the endpoint device.

### CONCLUSION

Techniques for partitioning media data are described. Although embodiments are described in language specific to structural features and/or methodological acts, it is to be understood that the embodiments defined in the appended claims are not necessarily limited to the specific features or acts described. Rather, the specific features and acts are disclosed as example forms of implementing the claimed embodiments.

What is claimed is:

1. A system comprising:
at least one processor; and
one or more computer-readable storage media including instructions stored thereon that, responsive to execution by the at least one processor, cause the system perform operations including:
encoding media data of a communication session to generate encoded media data;
applying a partitioning matrix to the encoded media data to generate a first partition and a second partition that each include different respective portions of the encoded media data;
transmitting the first partition for receipt by a first wireless radio system and for forwarding to a device as part of the communication session; and
transmitting the second partition for receipt by a second wireless radio system and for forwarding to the device as part of the communication session.

2. A system as recited in claim 1, wherein said applying the partitioning matrix punctures the encoded media stream to generate the first partition and the second partition.

3. A system as recited in claim 1, wherein said encoding causes the encoded media data to include redundant data, and wherein said applying the partitioning matrix causes the first partition to have a different amount of redundant data then the second partition.

4. A system as recited in claim 1, wherein said applying the partitioning matrix causes the first partition to have a different code rate then the second partition.

5. A system as recited in claim 1, wherein the operations further include selecting the partitioning matrix to maximize a Hamming distance between the first partition and the second partition.

6. A system as recited in claim 1, wherein the partitioning matrix is variable based on a detected signal quality for one or more of the first wireless radio system or the second wireless radio system.

7. A system as recited in claim 1, wherein the operations further include:
ascertaining that the first wireless radio system has a lower performance attribute than the second wireless radio system; and
selecting, responsive to said ascertaining, the partitioning matrix to provide a higher data redundancy in the first partition than in the second partition.

8. A system as recited in claim 1, wherein the device comprises one or more of an endpoint device, a network component, or an application residing on an endpoint device.

9. A system as recited in claim 1, wherein the operations further include, prior to transmitting the first partition and the second partition:
detecting multiple wireless radio systems that are available; and
selecting the first wireless radio system and the second wireless radio system as a subset of the multiple wireless radio systems and based on a performance attribute of one or more of the first wireless radio system or the second wireless radio system.

10. A system as recited in claim 1, wherein the operations further include, prior to transmitting the first partition and the second partition:
detecting multiple wireless radio system that are available; and
selecting one or more of the first wireless radio system or the second wireless radio system as a subset of the multiple wireless radio systems and based on one or more of the first wireless radio system or the second wireless radio system being identified as a preferred wireless radio system.

11. A computer-implemented method comprising:
detecting that multiple wireless radio systems are available to receive wireless transmission of encoded media data of a communication session;
selecting a first wireless radio system and a second wireless radio system from the multiple wireless radio systems and based on one or more criteria for selecting a wireless radio system;
applying a partitioning matrix to the encoded media data to generate a first partition and a second partition that each include different respective portions of the encoded media data;
transmitting the first partition for receipt by the first wireless radio system for forwarding to a device as part of the communication session; and
transmitting the second partition for receipt by the second wireless radio system for forwarding to the device as part of the communication session.

12. A method as described in claim 11, further comprising ascertaining that the one or more of the first wireless radio system or the second wireless radio system are indicated in an radio system database as a preferred wireless radio system.

13. A method as described in claim 11, further comprising selecting the partitioning matrix to maximize a Hamming distance between the first partition and the second partition.

14. A method as described in claim 11, further comprising selecting the partitioning matrix based on a performance attributes of one or more of the first wireless radio system or the second wireless radio system.

15. A method as described in claim 11, wherein the one or more attributes indicate that the first wireless radio system has a lower performance attribute than the second wireless radio system, and wherein said determining comprises determining the partitioning matrix to provide a higher data redundancy in the first partition than in the second partition.

16. A computer-implemented method comprising:
receiving separate partitions of media data of a communication session from different wireless radio systems, the separate partitions transmitted from a single client device; and
combining the separate partitions into a single media stream for output at an endpoint device as media content of the communication session.

17. A computer-implemented method as recited in claim 16, wherein said combining is performed at a network component prior to being received by the endpoint device.

18. A computer-implemented method as recited in claim 16, wherein said combining is performed at a wireless network controller prior to being received by the endpoint device.

19. A computer-implemented method as recited in claim 16, wherein said combining is performed at a wireless driver level of the endpoint device.

20. A computer-implemented method as recited in claim 16, wherein said combining is performed at an application of the endpoint device.
